(19) United States
(12) Patent Application Publication
(10) Pub. No.: US 2018/0251966 A1
(43) Pub. Date: Sep. 6, 2018

(54) RUBINETTO A SINGOLO INGRESSO A GETTO NEBULIZZATO E INSERTO NEBULIZZATORE PER DETTO RUBINETTO

(71) Applicant: EFFEBI S.p.A., Bovezzo (IT)

(72) Inventors: Ermanno TANGHETTI, Concesio (IT); Alberto SALA, BOVEZZO (IT)

(21) Appl. No.: 15/907,585

(22) Filed: Feb. 28, 2018

(30) Foreign Application Priority Data
Feb. 28, 2017 (IT) 2020170000022484

(51) Int. Cl. E03C 1/08; F16L 55/07; F16K 1/14

(52) U.S. Cl. CPC E03C 1/08; F16K 1/14; F16L 55/07

(57) ABSTRACT

A single-entry faucet is provided with a delivery duct, a supply duct and a nebulizer insert coupled to the outlet of the delivery duct.

### PRIORITY CLAIM

This application claims priority from Italian Utility Model Application No. 202017000022484 filed on Feb. 28, 2017, the disclosure of which is incorporated by reference

### TECHNICAL FIELD

The present invention relates to a nebulized-jet single-entry faucet and to a nebulizer insert for said faucet.

### BACKGROUND OF THE INVENTION

Single-entry faucets are normally used in public spaces (parks, swimming pools, public baths), in gardens and in laundries where there is no need to mix water at different temperatures.

In fact, faucets of this type receive water from a single pipe, in which cold water generally flows.

Normally, faucets of this type usually comprise a ball shut-off valve.

This type of valve, in fact, guarantees the passage of high flow rates with minimal load losses. Consequently, in this type of valves, turbulence phenomena are reduced to a minimum.

The closure is quick and easy, since it just requires a simple 90° rotation of the knob coupled to the valve.

Moreover, the ball shut-off valves are not sensitive to temperature variations and, above all, they are particularly resistant to low temperatures. For these reasons, they are therefore particularly suitable for outdoor installations.

Since these faucets are often used in public places, where the users' attention to consumption is often very low, trying to minimize waste is essential.

Known faucets provide for the use of timed closure systems. However, this solution is not always adoptable in places where the faucet must be usable even for a longer time than the preset one.

### SUMMARY OF THE INVENTION

It is therefore an object of the present invention to provide a single-entry faucet, which is able to reduce the overall water consumption and which, at the same time, does not modify the consumer's habits.

According to this object, the present invention relates to a single-entry faucet comprising a delivery duct, a supply duct and a nebulizer insert coupled to the outlet of the delivery duct.

A further object of the invention is to provide a nebulizer insert for a single-entry faucet that is easy to install on single-entry faucets and that is at the same time simple and inexpensive to manufacture.

According to this object, the present invention relates to an insert for a single-entry faucet comprising a passage channel and a nebulization device arranged inside the passage channel, the nebulization device being designed to nebulize the fluid passing through the passage channel in order to generate an outgoing nebulized jet.

### BRIEF DESCRIPTION OF THE DRAWINGS

Further characteristics and advantages of the present invention will be clear from the following description of a non-limiting embodiment, with reference to the Figures of the accompanying drawings, in which:

FIG. 1 is a schematic side view, with parts in section and parts removed for clarity's sake, of a single-entry faucet according to the present invention;

FIG. 2 is an enlargement of the detail II of FIG. 1;

FIG. 3 is a schematic side view, with parts in section and parts removed for clarity's sake, of a single-entry faucet according to a first variant of the present invention;

FIG. 4 is a schematic side view, with parts in section and parts removed for clarity's sake, of a single-entry faucet according to a second variant of the present invention;

FIG. 5 is a schematic side view, with parts in section and parts removed for clarity's sake, of a single-entry faucet according to a third variant of the present invention.

### DETAILED DESCRIPTION OF THE INVENTION

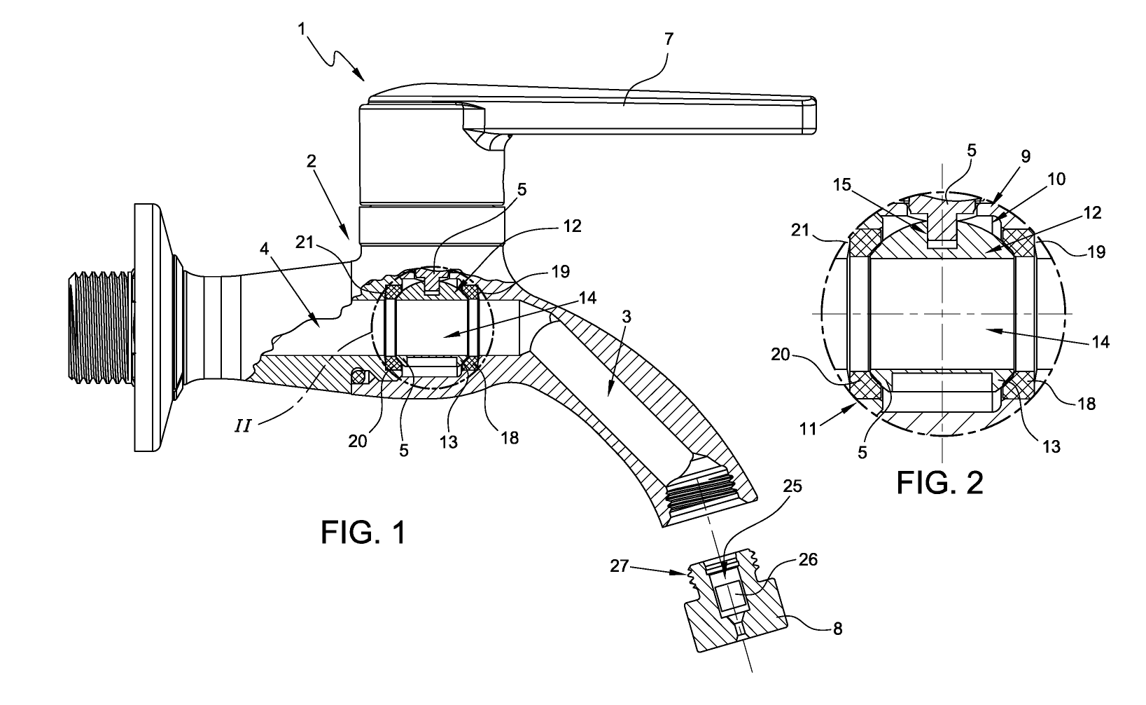

In FIG. 1, the reference number 1 indicates a faucet according to the present invention.

The faucet 1 is a single-entry faucet. A single-entry faucet means a faucet having only one inlet that can be coupled to a single pipe.

In the non-limiting example here described and shown, the faucet 1 is a garden faucet coupled to a pipe (not shown for simplicity's sake in the attached Figures) in which unheated water flows.

It is clear that the faucet 1 can be coupled to a pipe in which heated water, or any other type of fluid at any temperature, flows.

A faucet means a device applied to the end of the supply pipe. Therefore, the term “faucet” means both the devices for interrupting and regulating the flow coming from the pipe and the simple continuous delivery ports, which are used e.g. in public fountains.

The faucet 1 comprises a valve 2, preferably a ball valve 2, a delivery duct 3, a supply duct 4 coupled to the supply pipe (not shown), an actuator 5 (partially visible in FIG. 1) coupled to the ball valve 2 and a lever 7 coupled to the actuator 5.

The faucet 1 further comprises a nebulizer insert 8 arranged at the outlet of the delivery duct 3.

With reference to FIG. 1 and to the enlargement of FIG. 2, the ball valve 2 comprises a valve body 9 provided with a seat 10 coupled to the supply duct 4 and to the delivery duct 3 and sealing means 11. The seat 10 houses a shutter 12.

The shutter 12 is coupled to the actuator 5 through a kinematic transmission system and is movable between an open position (shown in FIG. 1), wherein the water flow coming from the supply duct 4 is supplied to the delivery duct 3, and a closed position (not shown in the attached Figures), wherein the water flow coming from the supply duct 4 is blocked by the shutter 12 and is not supplied to the delivery duct 3.

In particular, the shutter 12 comprises a main body 13, preferably hollow and spherical in shape.

The main body 13 comprises a through inner channel 14 and a groove 15, formed on the outer surface of the main body 13 and adapted to be engaged by a portion of the actuator 5 so that a rotation of the actuator 5 causes a corresponding rotation of the shutter 12.

Preferably, the portion of the actuator 5 engages the groove 15 with a clearance, so that, in the closed position, the shutter 12 is tilting about an axis orthogonal to the axis along which the inner channel 14 extends. The tilting of the shutter 12 optimizes the tightness of the faucet 1 when the shutter 12 is in the closed position.

In the open position, the shutter 12 is arranged so that the inner channel 14 is substantially aligned with the supply duct 4 and with the delivery duct 3 to allow the passage of water (configuration of FIG. 1), while in the closed position the shutter 12 is arranged so that the inner channel 14 is not in communication with the delivery duct 3 and so that the outer surface of the main body 13 occludes the passage of liquids from the supply duct 4 to the delivery duct 3 or vice versa.

The outer surface of the main body 13 of the shutter 12 is usually chrome-plated. A variant provides that the outer surface of the main body 13 of the shutter 12 is at least partially made of a material resistant to the adhesion of limestone deposits, e.g. a PTFE-based material.

The actuator 5, as already partially anticipated, has a portion coupled to the shutter 12 and a portion (not visible in the attached Figures) coupled to the lever 7. In use, the rotation of the lever 7 causes a rotation of the actuator 5 and a consequent rotation of the shutter 12.

A variant not shown provides that the actuator is made in one piece with the shutter.

In the non-limiting example here described and shown, the sealing means 11 comprise at least a sealing element 18 arranged between the shutter 12 and a shoulder 19 of the delivery duct 3 and a sealing element 20 arranged between the shutter 12 and a shoulder 21 of the supply duct 4.

Preferably, also the sealing element 18 and the sealing element 20 are made of a material resistant to limestone adhesion, e.g. the same PTFE-based material used to coat the shutter 12.

In the non-limiting example here described and shown, the insert 8 is removable and coupled to the delivery duct 3 by means of a threaded coupling.

A variant, not shown, provides that the insert 8 is made in one piece with the delivery duct 3. In particular, the insert 8 contains a passage channel 25 and a nebulization device 26 (schematically represented in the attached Figures) arranged inside the passage channel 25.

The nebulization device 26 is designed to nebulize the fluid passing through the passage channel 25 to generate a real nebulized jet coming out of the faucet 1.

In particular, the nebulization device 26 is designed to turn the incoming liquid flow into a plurality of very small drops, thus substantially giving rise to a mist. In other words, the nebulization device 26 is designed to turn the incoming liquid flow into a plurality of droplets having a diameter of the order of microns.

The size of the droplets depends on the fluid pressure at the inlet of the nebulization device 26. This pressure depends on the original pressure of the fluid coming from the supply pipe (usually depending on the network water pressure) and on the user's adjustment of the valve 2.

In particular, the nebulization device 26 is designed to generate a cone-shaped jet having an even distribution.

In the non-limiting example here described and shown, the nebulization device 26 is designed to increase the speed and pressure of the water to generate a sort of “turbine” effect, which produces a sufficiently nebulized jet.

In the hydraulic field, the term “nebulizer” is sometimes replaced by the term “atomizer”. It is therefore clear that the nebulization device 26 can also be defined as an atomization device 26.

The nebulizer insert 8 greatly reduces water consumption in single-entry faucets.

The nebulizer insert 8, in fact, considerably reduces the inlet flow rate.

Preferably, the nebulizer insert 8 is designed to reduce the inlet flow rate by at least 70%.

In the non-limiting example here described and shown, the nebulizer insert 8 is designed to reduce the inlet flow rate by 90%.

In fact, these faucets are generally designed to supply high flow rates (e.g. to irrigate, to fill buckets, to wash cars), but they are also used for activities that do not require high flow rates (e.g. washing hands, washing and rinsing items of various kinds, rinsing feet, etc.).

Basically, the nebulizer insert 8 can significantly reduce water consumption without substantially changing the user's perception and habits.

The nebulizer insert 8 is preferably provided with a threaded end 27 having with a thread that meets the requirements of the UNI-ISO 228/1 and/or ISO 7/1 and/or EN 10226 threading standards.

The UNI-ISO 228/1 and/or ISO 7/1 and/or EN 10226 threading rules define specific threading geometries that guarantee seals suitable for the application object of the present invention.

This specific thread, in fact, guarantees a high seal and a high compatibility of the nebulizer insert 8 with most of the presently commercially available single-entry faucets.

This advantageously allows applying the nebulizer insert 8 even to already installed single-entry faucets.

In the non-limiting example here described and shown in FIG. 1, the nebulizer insert 8 has a threaded end 27 with a male thread.

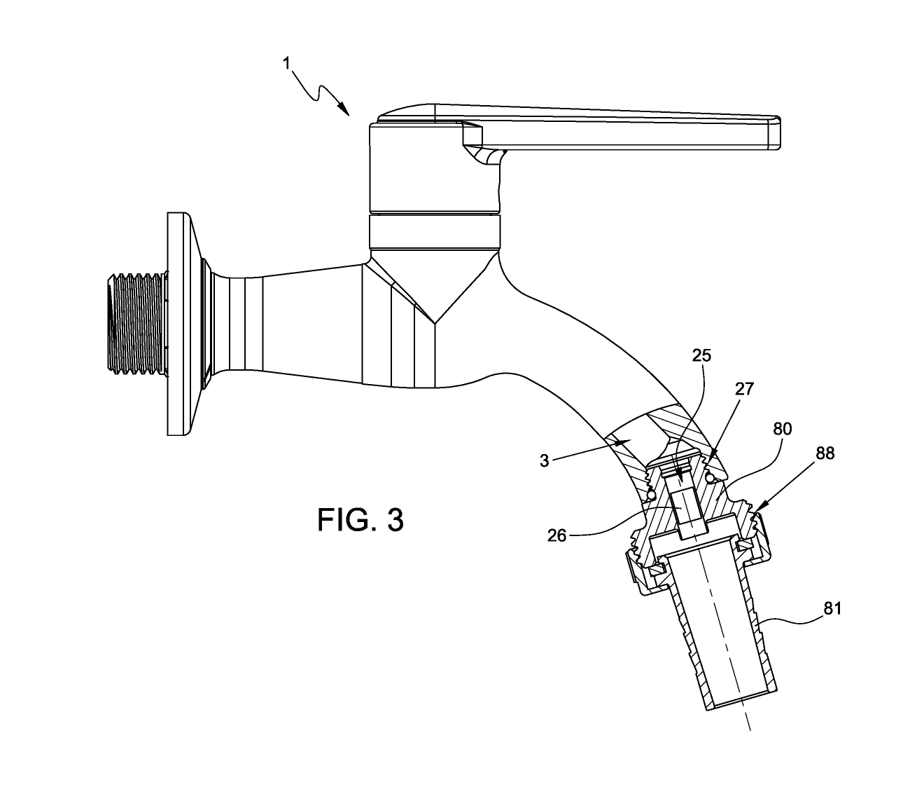

On the other hand, FIG. 3 shows a second embodiment of a nebulizer insert 80.

FIG. 3 substantially maintains the same reference numbers of the description of FIG. 1 referring to similar or substantially identical parts.

The nebulizer insert 80 comprises the nebulization device 26 and differs from the nebulizer insert 8 in that it comprises a second threaded end 88, opposite the end 27. As already stated above, the nebulizer insert 80 can also be made in one piece with the delivery duct 3.

The second end 88 is threaded with a thread that meets the requirements of the UNI-ISO 228/1 and/or ISO 7/1 and/or EN 10226 threading standards. Preferably, the threaded end 88 has a male thread. In the non-limiting example here described and shown, the end 88 is coupled to a further insert 81, normally called “rubber holder”, provided with an externally knurled end to facilitate the coupling with an irrigation flexible hose (not shown). It is clear that the second end 88 can be coupled to any other compatible insert and not necessarily to a “rubber holder”.

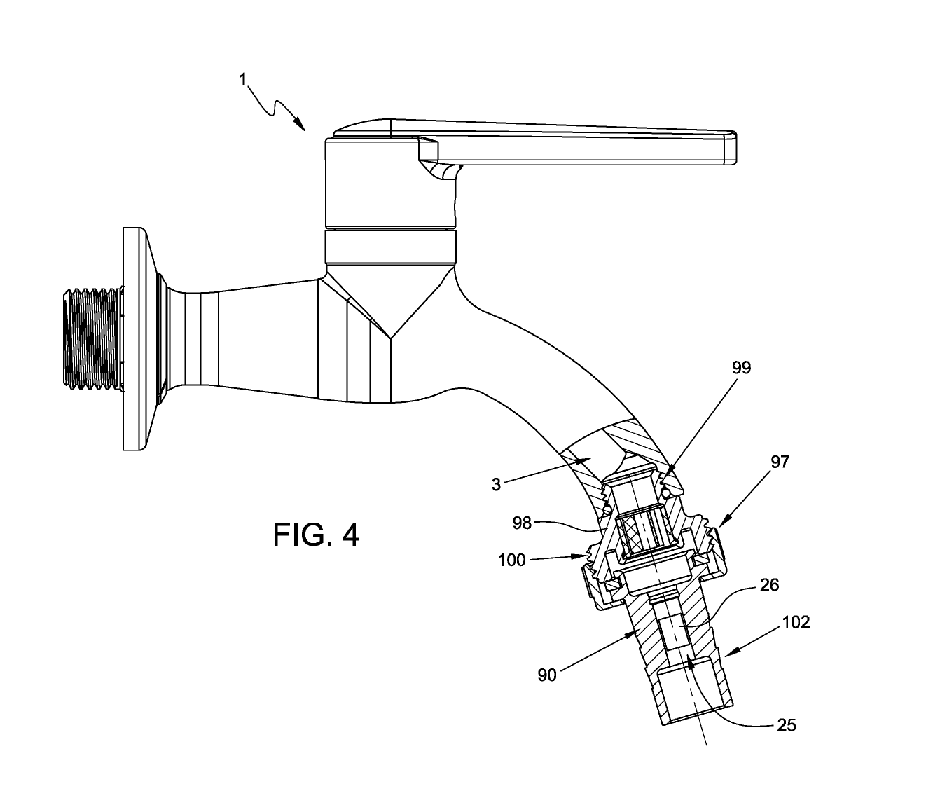

FIG. 4 shows a third embodiment of a nebulizer insert 90.

FIG. 4 substantially maintains the same reference numbers of the description of FIG. 1 referring to similar or substantially identical parts.

The nebulizer insert 90 comprises the nebulization device 26 and initially differs from the nebulizer insert 8 because it is not coupled directly to the delivery duct 3. The nebulizer insert 90, in fact, is provided with a first end 97 coupled to a junction 98 designed to connect the nebulizer insert 90 to the delivery duct 3. Preferably, the junction 98 is designed to house nebulizer inserts 90 having a diameter different from the diameter of the outlet of the delivery duct 3.

In fact, the junction 98 has an end 99 (coupled to the delivery duct 3) having a first diameter and a second end 100 (coupled to the nebulizer insert 90) having a different diameter. The junction 98 can be made in one piece with the delivery duct 3.

Preferably, the end 100 is threaded with a thread that meets the requirements of the UNI-ISO 228/1 and/or ISO 7/1 and/or EN 10226 threading standards. Preferably, the end 100 is threaded with a male thread.

The first end 97 of the nebulizer insert 90 is threaded with a thread that meets the requirements of the UNI-ISO 228/1 and/or ISO 7/1 and/or EN 10226 threading standards. Preferably, the first end 97 is threaded with a female threading, which can be coupled to the end 100 of the junction 98. In the non-limiting example here described and shown, the nebulizer insert 90 is also a “rubber holder”, since it has an externally knurled second end 102 to facilitate its coupling with an irrigation flexible hose (not shown). It is clear that the nebulization device 26 can also be integrated in kinds of inserts other than the “rubber holder” to integrate the nebulization function with other known functions.

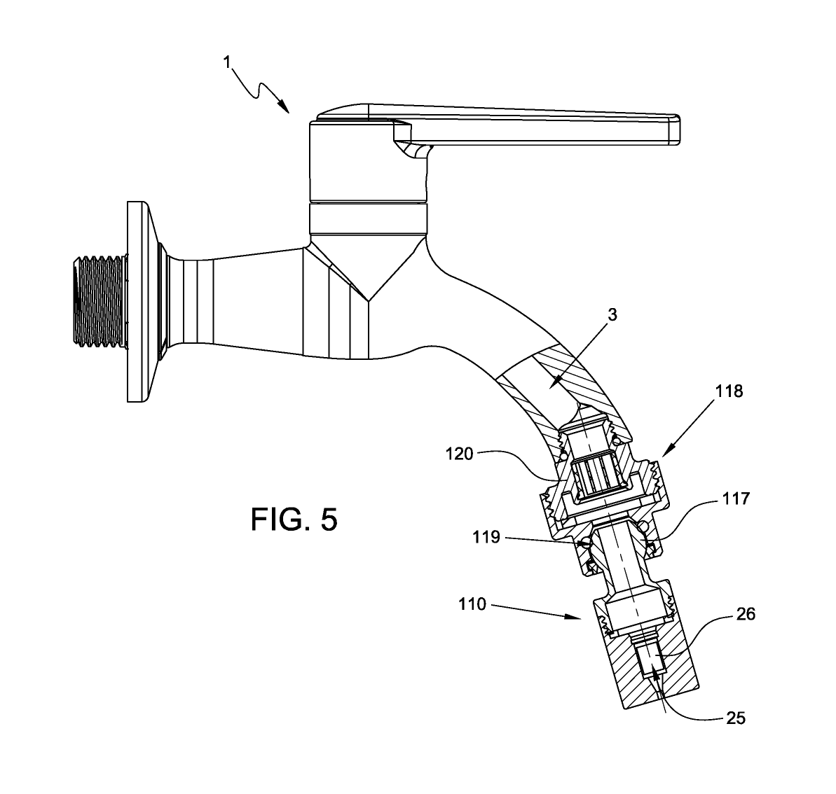

FIG. 5 shows a fourth embodiment of a nebulizer insert 110.

FIG. 5 substantially maintains the same reference numbers of the description of FIG. 1 referring to similar or substantially identical parts.

The nebulizer insert 110 comprises the passage channel 25 and the nebulization device 26 (schematically shown in the attached Figures) arranged inside the passage channel 25.

The nebulizer insert 110 differs from the nebulizer insert 8 substantially in that it is not coupled directly to the delivery duct 3. The nebulizer insert 110, in fact, is coupled to a junction 118, in turn coupled to the delivery duct 3.

The coupling between the nebulizer insert 110 and the junction 118 is a spherical coupling (usually referred to as a “joint”).

The nebulizer insert 110 is, in fact, preferably provided with a first substantially spherical end 117, which is housed in a substantially spherical seat 119 of the junction 118.

It is clear that the spherical coupling can also be carried out inversely by means of a spherical seat formed at the first end 117 of the nebulizer insert 110 adapted to be engaged by a spherical head pin of the junction 118 (embodiment not shown in the attached Figures).

In the non-limiting example here described and shown, the junction 118 is coupled by threading to a further junction 120 fixed to the delivery duct 3. A variant, not shown, provides that the junction 118 and/or the junction 120 are made in one piece with the delivery duct 3.

A further variant, not shown, provides that the junction 118 is coupled with a joint to a nebulizer and/or aerator insert or to an aerator insert.

A further variant, not shown, provides that the nebulizer insert is provided with a first end shaped to be snap-coupled to an element coupled to the delivery duct 3 or directly to the delivery duct 3.

Finally, it is evident that modifications and variations can be made to the faucet and insert described herein without departing from the scope of the appended claims.

1. Single-entry faucet comprising a delivery duct, a supply duct and a nebulizer insert coupled to the outlet of the delivery duct.

2. A faucet according to claim 1, comprising a valve arranged between the supply duct and the delivery duct.

3. A faucet according to claim 1, wherein the nebulizer insert is coupled directly to the delivery duct.

4. A faucet according to claim 1, wherein the delivery duct and the nebulizer insert are made in one piece.

5. A faucet according to claim 1, wherein the nebulizer insert is coupled to the outlet of the delivery duct by means of a junction.

6. A faucet according to claim 2, wherein the valve is a shut-off valve.

7. A faucet according to claim 2, wherein the valve is a ball valve.

8. A faucet according to claim 1, wherein the nebulizer insert comprises a passage channel and a nebulization device arranged inside the passage channel; the nebulization device being designed to nebulize the fluid passing through the passage channel so as to generate an outgoing nebulized jet.

9. A faucet according to claim 8, wherein the nebulization device is designed to turn the incoming liquid flow into a plurality of drops having a diameter of the order of microns.

10. Nebulizer insert for a faucet of the type claimed in claim 1, comprising a passage channel and a nebulization device arranged inside the passage channel; the nebulization device being designed to nebulize the fluid passing through the passage channel so as to generate an outgoing nebulized jet.

11. A nebulizer insert according to claim 10, provided with a first threaded end having a thread that meets the requirements of the UNI-ISO 228/1 and/or ISO 7/1 and/or EN 10226 threading standards.

12. A nebulizer insert according to claim 11, provided with a second end opposite the first end; the second end being threaded with a thread that meets the requirements of the UNI-ISO 228/1 and/or ISO 7/1 and/or EN 10226 threading standards.

13. A nebulizer insert according to claim 11, provided with a second end opposite the first end; the second end being externally knurled.

14. A nebulizer insert according to claim 10, provided with a first end shaped to be coupled with spherical coupling to an element coupled to the delivery duct.

15. A nebulizer insert according to claim 12, wherein the first end has a substantially spherical shape and is sized to be housed in a suitable spherical seat of the element coupled to the delivery duct.

16. A nebulizer insert according to claim 11, provided with a first end shaped to be snap-coupled to an element coupled to the delivery duct or directly to the delivery duct.
